(19) United States
(12) Patent Application Publication
(10) Pub. No.: US 2016/0167722 A1
(43) Pub. Date: Jun. 16, 2016

(54) Snow Bike Rear Suspension System

(71) Applicant: Raptor Performance Shocks, LLC, Warroad, MN (US)

(72) Inventors: Jake R. Anderson, Warroad, MN (US); Timothy J. Giese, White Bear Township, MN (US)

(73) Assignee: Raptor Performance Shocks, LLC

(21) Appl. No.: 14/966,756

(22) Filed: Dec. 11, 2015

Related U.S. Application Data
(60) Provisional application No. 62/090,530, filed on Dec. 11, 2014.

(51) Int. Cl. B62D 55/104; B62D 55/112; B62M 27/02; B62D 55/108

(52) U.S. Cl. CPC B62D 55/104; B62D 55/108; B62D 55/1125; B62M 27/02; B62M 2027/026

(57) ABSTRACT

A snow bike rear suspension system for providing a rear suspension to a snow bike. The snow bike rear suspension system generally includes a snow bike rear suspension system, which comprises a chassis structure, driveline, brake system, and rear track suspension used to convert a late model off-road motorcycle into a snow vehicle capable of traversing both deep and hard packed snow.

### CROSS REFERENCE TO RELATED APPLICATIONS

I hereby claim benefit under Title 35, United States Code, Section 119(e) of U.S. provisional patent application Ser. No. 62/090,530 filed Dec. 11, 2014. The 62/090,530 application is currently pending. The 62/090,530 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a snow bike and more specifically it relates to a snow bike rear suspension system for providing a rear suspension to a snow bike.

2. Description of the Related Art

Any discussion of the related art throughout the specification should in no way be considered as an admission that such related art is widely known or forms part of common general knowledge in the field.

Snow bikes are comprised of a conventional motorcycle (typically an off-road motorcycle) converted to have a track similar to a snowmobile for the rear suspension and a single ski attached to the front for the front suspension. Conventional snow bike kits are available that include a track for the rear suspension and a single ski for the front suspension. Snow bikes may also be constructed by an original equipment manufacturer (OEM).

### BRIEF SUMMARY OF THE INVENTION

Provided herein is a rear suspension for a snow bike which includes a snow bike rear suspension system, which comprises a chassis structure, driveline, brake system, and rear track suspension used to convert a late model off-road motorcycle into a snow vehicle capable of traversing both deep and hard packed snow.

One object is to provide a snow bike rear suspension system for modifying an off-road motorcycle suspension to make it suitable for operation in deep and hard pack snow.

Another object is to provide a snow bike rear suspension system that may be utilized upon various models of off-road motorcycles.

Another object is to provide a snow bike rear suspension system that may be attached to an off-road motorcycle as an after-market kit to replace the rear wheel of the motorcycle or manufactured by an OEM as a complete snow bike.

Another object is to provide a snow bike rear suspension system that is of modular type construction that requires no welding.

Another object is to provide a snow bike rear suspension system that has parameters such as front arm placement and wheel size and placement that has been designed to provide for improved weight transfer and traction. The uncoupled short track design also improves the ride and weight transfer for this type of vehicle.

Another object is to provide a snow bike rear suspension system wherein chain tension adjustment may be accomplished by unique eccentric adjusters.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a left side view of one embodiment for the snow bike rear suspension system.

FIG. 2 is a right side view of the snow bike rear suspension system.

FIG. 3 is a lower perspective view of the snow bike rear suspension system.

FIG. 4 is a lower perspective view of the snow bike rear suspension system.

FIG. 5 is a lower perspective view of the snow bike rear suspension system.

FIG. 6 is a lower perspective view of the snow bike rear suspension system.

FIG. 7 is a side view of the snow bike rear suspension system.

FIG. 8 is a side view of the snow bike rear suspension system.

FIG. 9 is a side view of the snow bike rear suspension system.

FIG. 10 is a side view of the snow bike rear suspension system.

FIG. 11 is a side view of the snow bike rear suspension system.

FIG. 12 is a side view of the snow bike rear suspension system.

FIG. 13 is a side view of the snow bike rear suspension system connected to a motorcycle frame to form a snow bike.

FIG. 14 is an exploded side view of the snow bike rear suspension system with respect to a motorcycle frame.

### DETAILED DESCRIPTION OF THE INVENTION

### A. Overview.

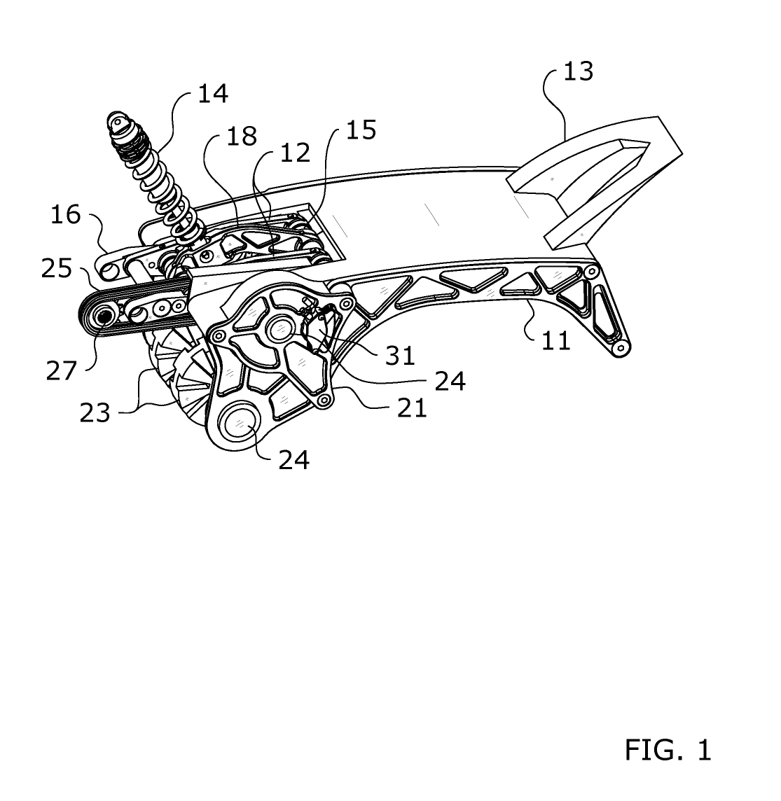

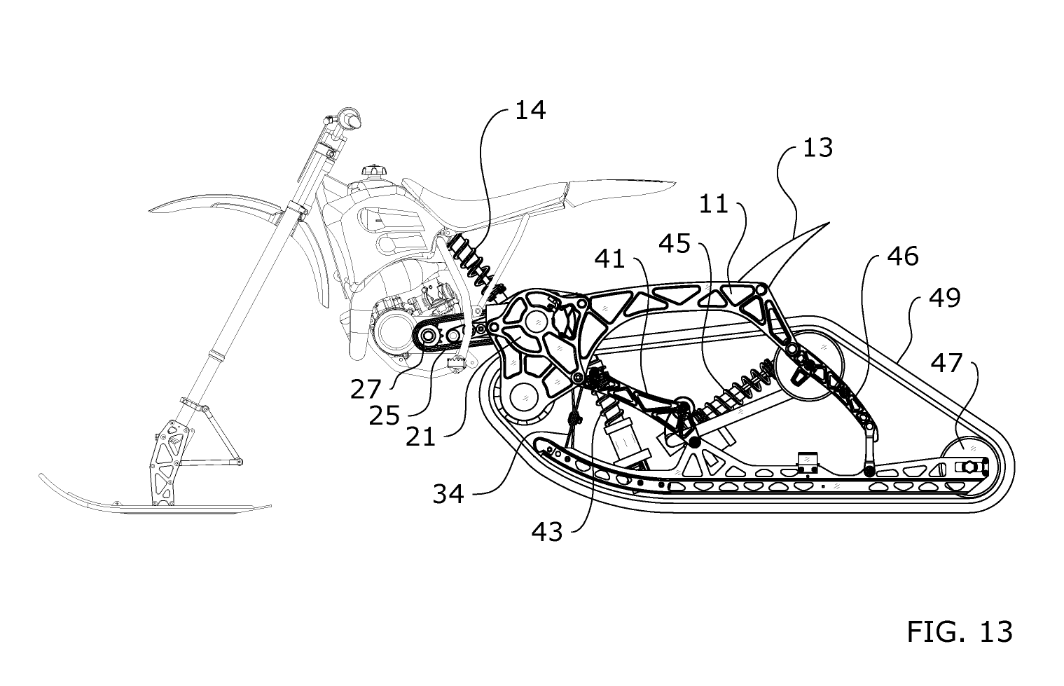

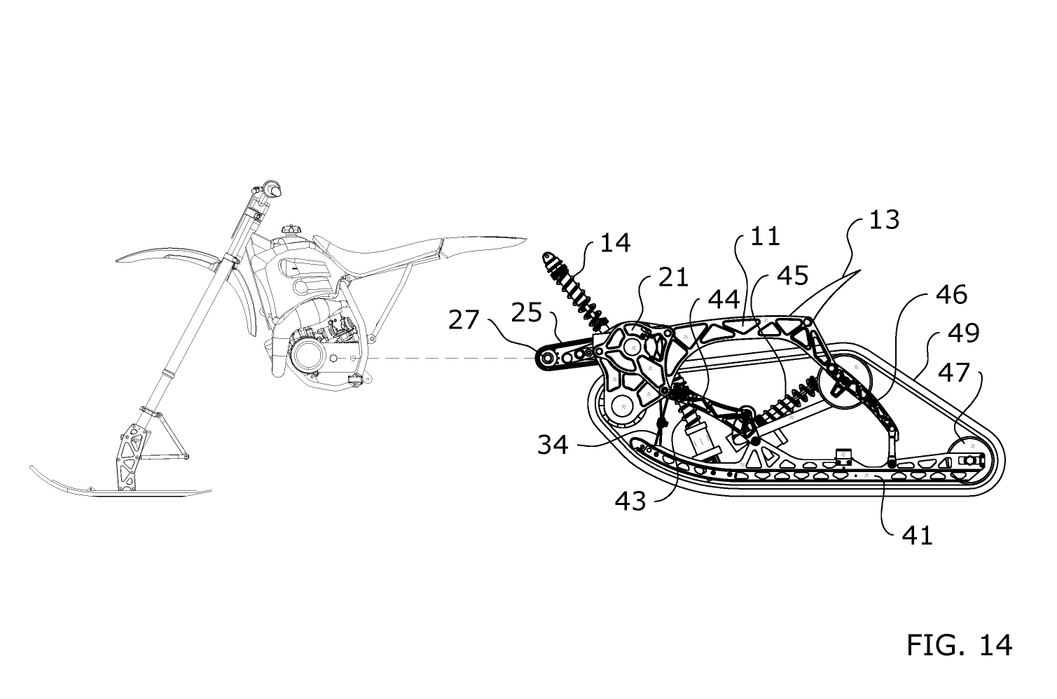

Turning now descriptively to the drawings, in which similar reference characters denote similar elements throughout the several views, FIGS. 1 through 14 illustrate a snow bike rear suspension system, which comprises a chassis structure, driveline, brake system, and rear track suspension used to convert a late model off-road motorcycle into a snow vehicle capable of traversing both deep and hard packed snow. The present invention may be manufactured as an after-market product attachable to an existing motorcycle frame to replace the rear wheel of the motorcycle or attached to a motorcycle frame at a factory as an OEM product.

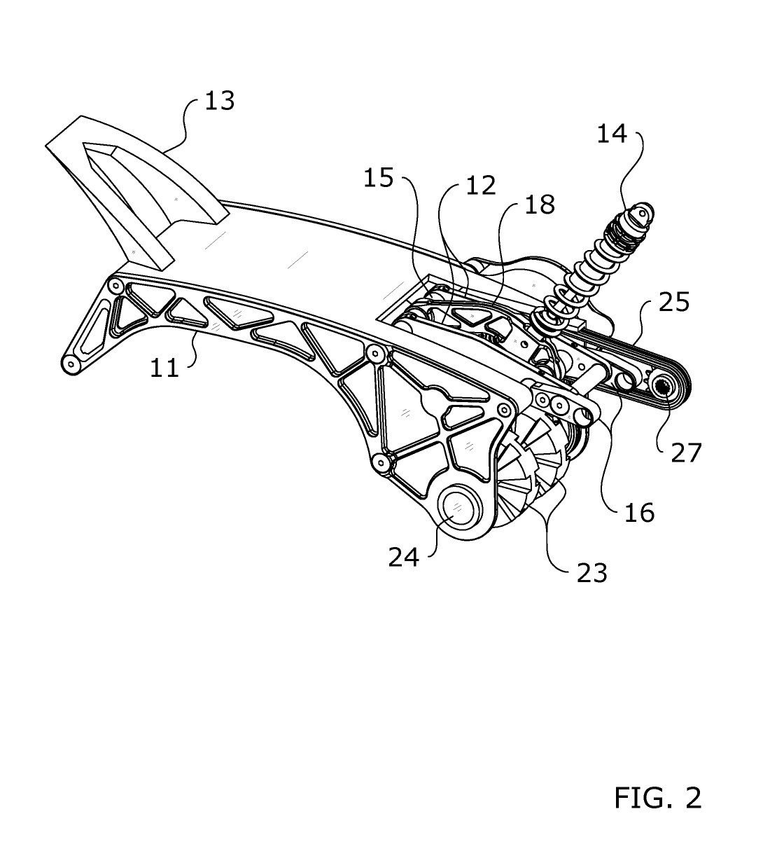

FIG. 1 is a left side view of the chassis assembly and FIG. 2 is a right side view of the chassis assembly. The front sprocket mounts to motorcycle output shaft. Front chassis connection mounts to motorcycle swing arm pivot. The upper link is compliant (here shown as a spring) and mounts to motorcycle upper rear shock location. Chassis structure provides mounts for jackshaft, driveshaft, rear suspension, fenders, and potential storage.

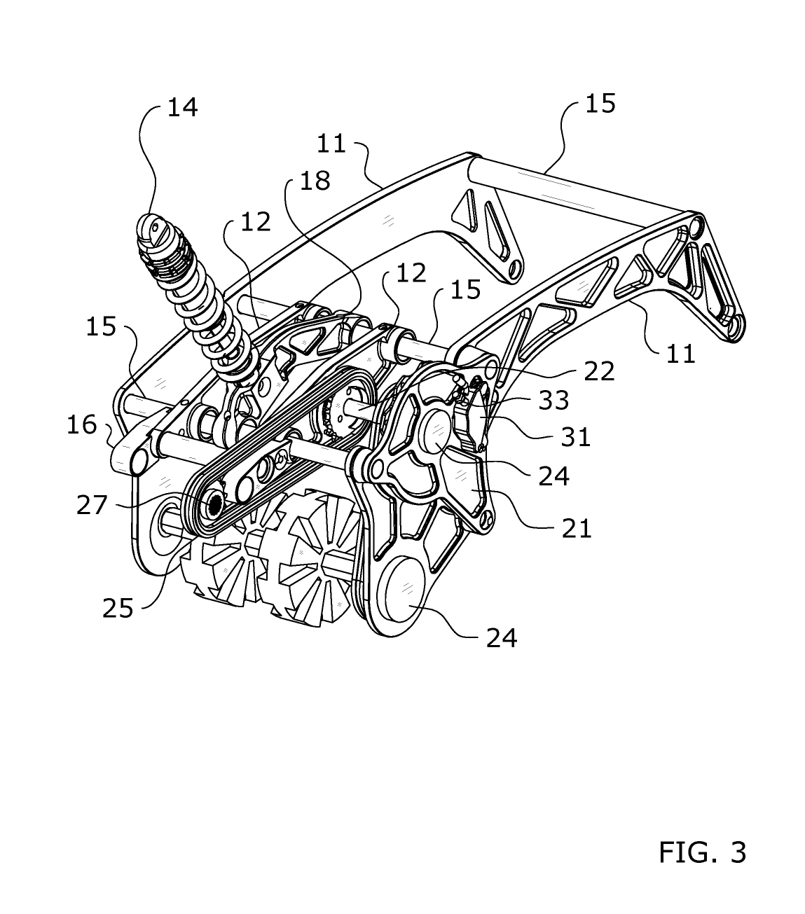

FIG. 3 is a lower perspective view of one embodiment of the present invention. This figure illustrates the method of construction consisting of main side plates and cross tubes. It also shows inside plates that locate the driveline, brakes, and compliant link.

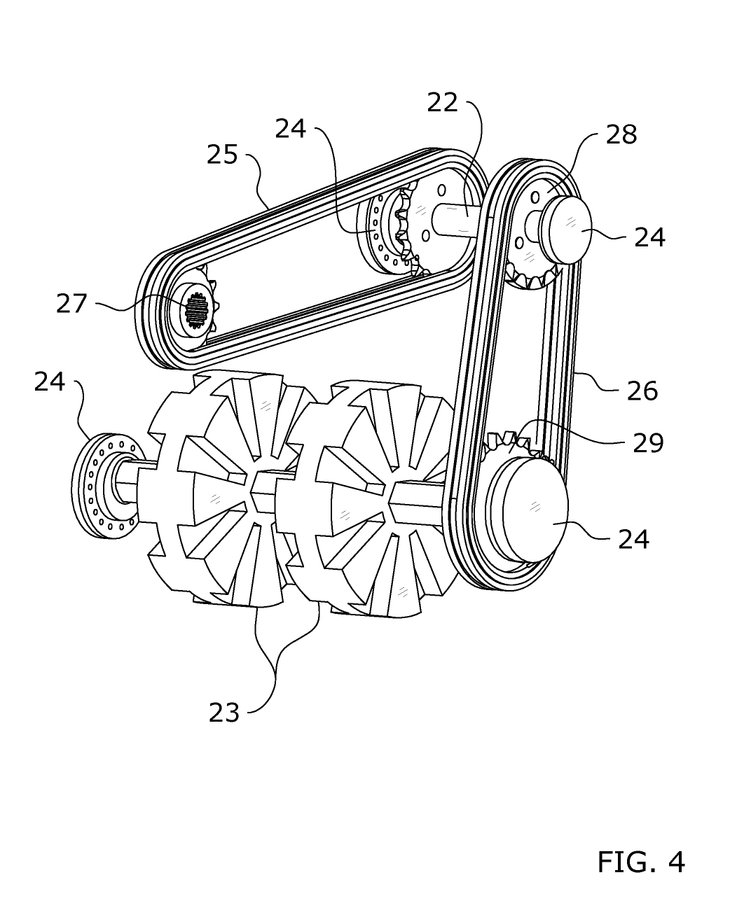

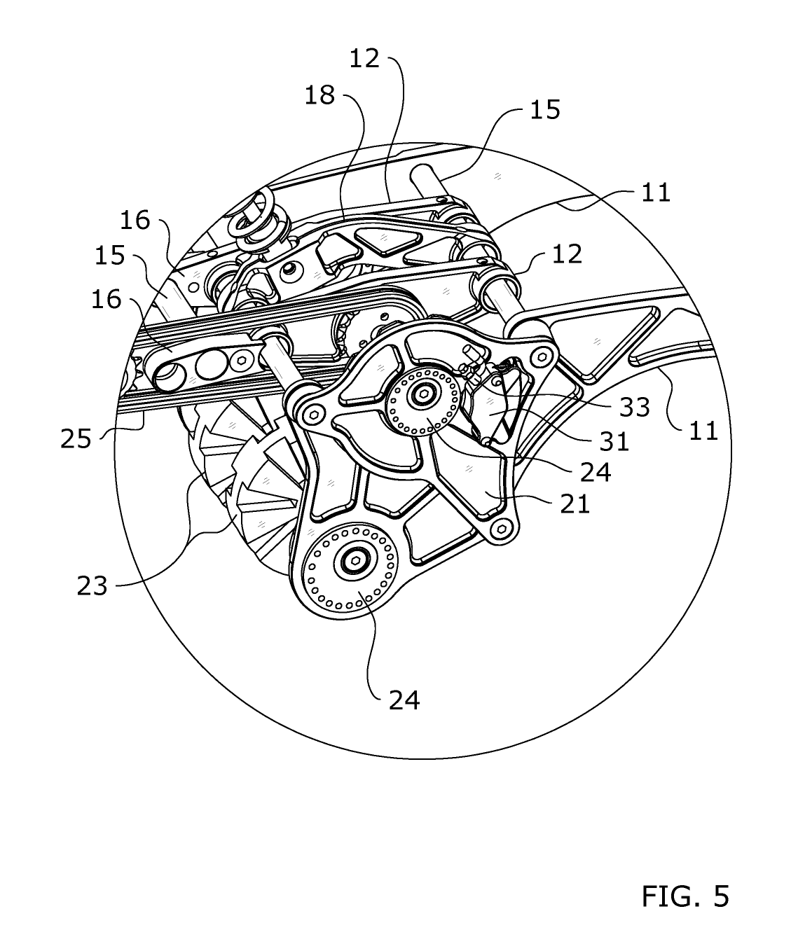

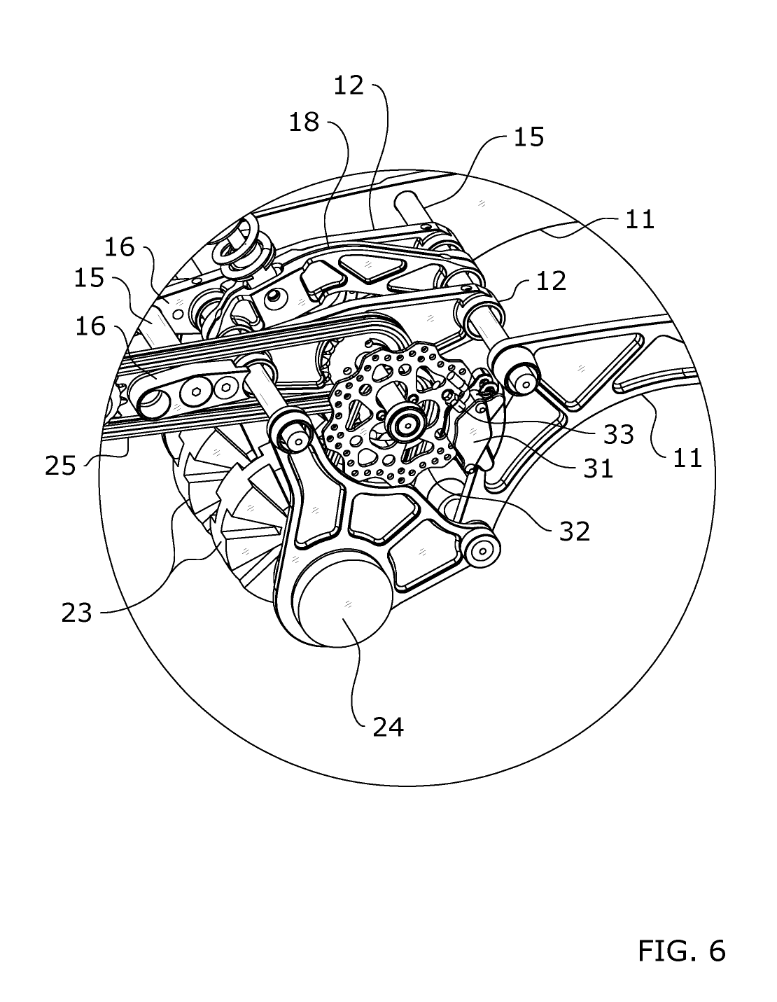

FIG. 4 is a lower perspective view illustrating the driveline architecture consisting of a driveshaft, jackshaft, sprockets, and chains. FIG. 5 is a lower perspective view illustrating the eccentrics mounted in side plates that allow adjustment of chain tension. FIG. 6 is a lower perspective view illustrating the location of the disc brake on the jackshaft on the inside of the left hand plate. It also shows integration of caliper with side plate.

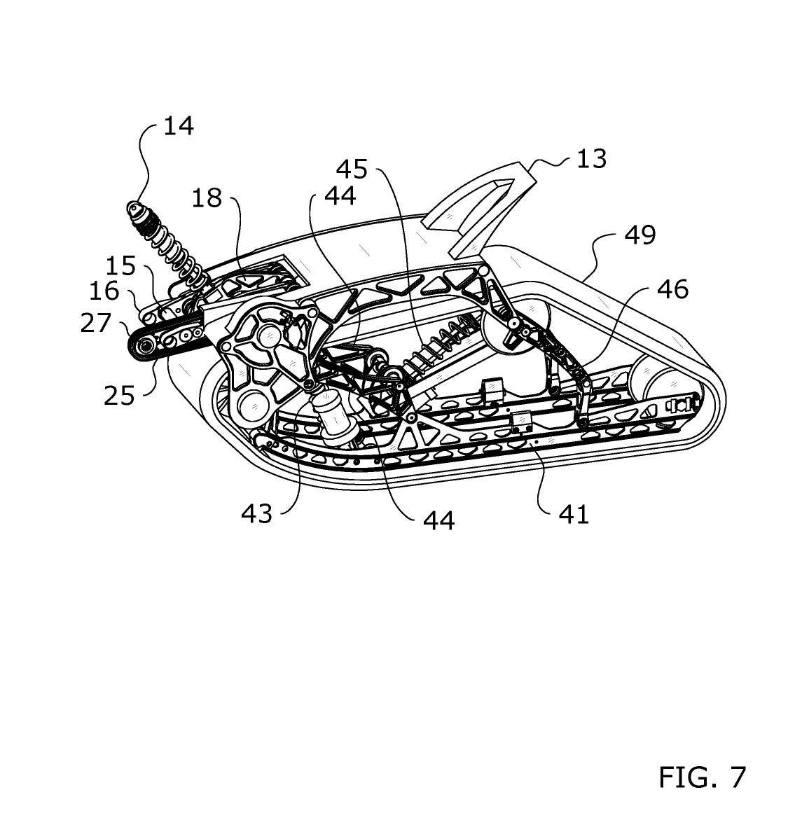

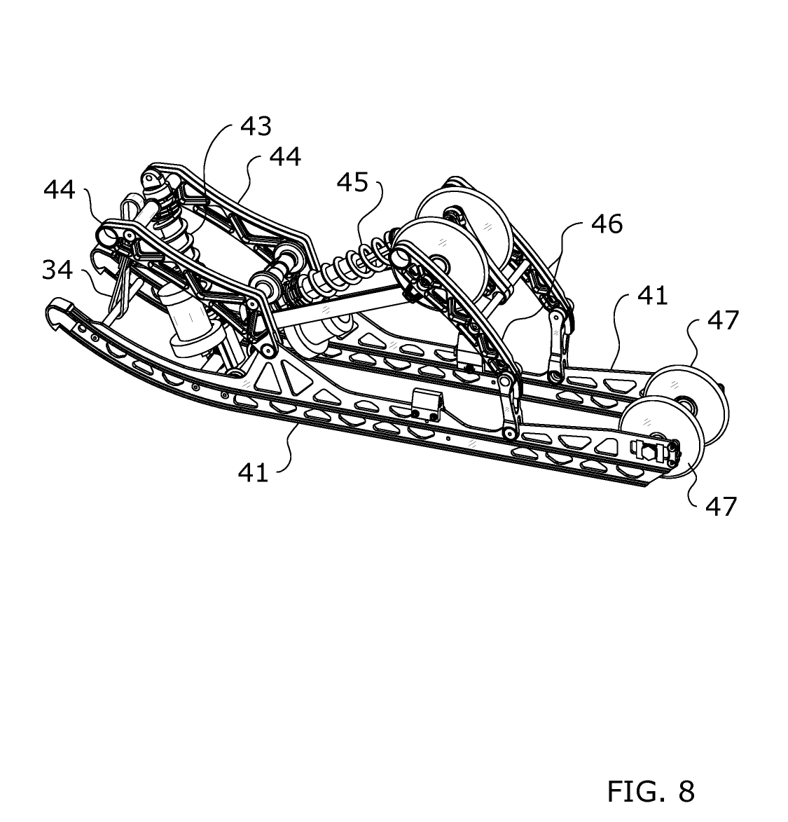

FIG. 7 is a side view illustrating how the rear suspension is mounted to the chassis structure. FIG. 8 is a side view illustrating the construction method of rear suspension consisting of main arms and cross shafts. It also illustrates the architecture of rear suspension consisting of traditional front track shock and linkage driven rear track shock. Also note the suspension is uncoupled.

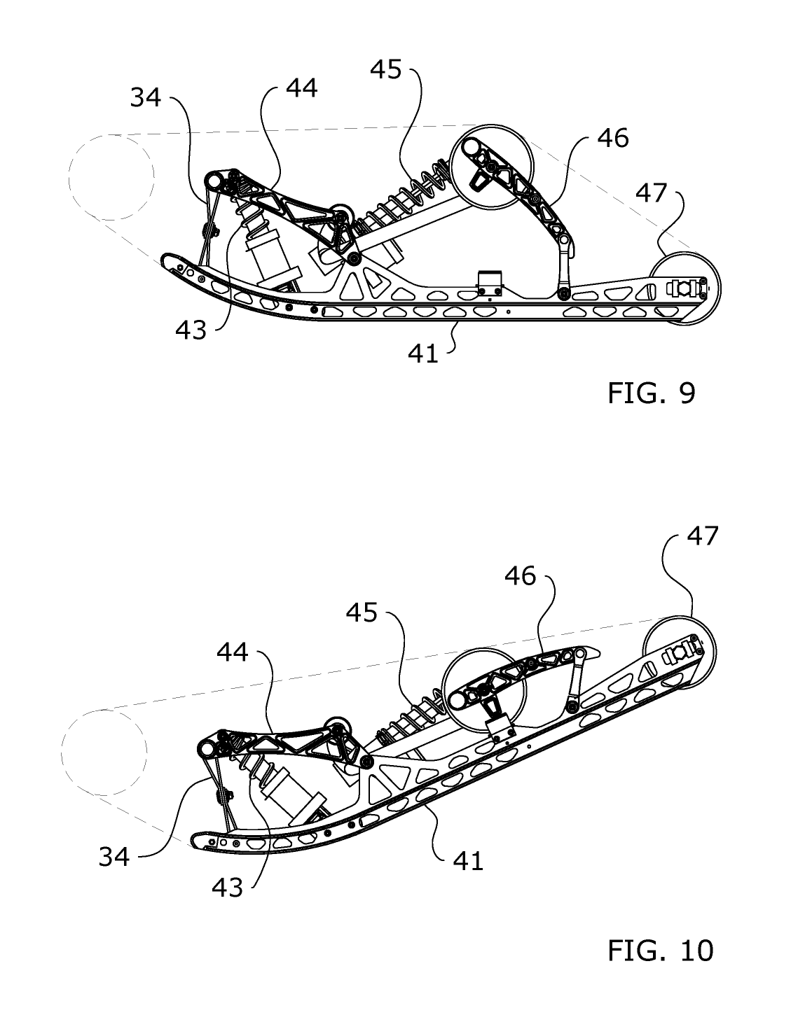

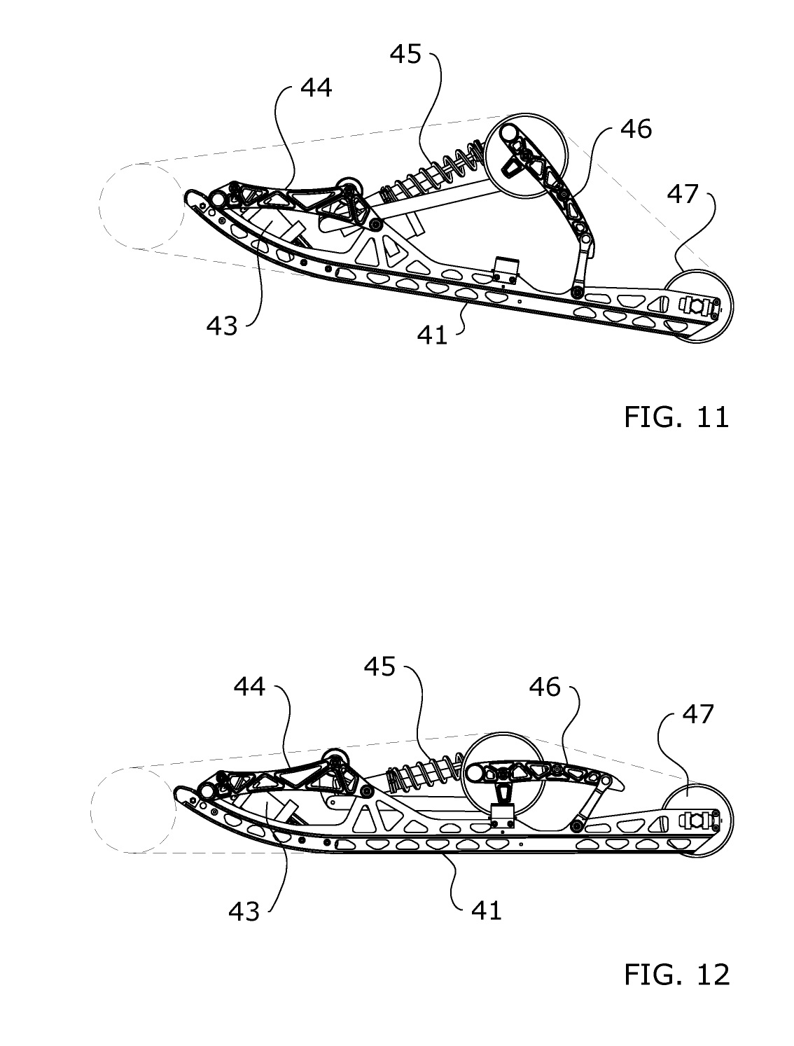

FIG. 9 is a side view of the rear suspension, full rebound side view of rear suspension with shocks fully extended. FIG. 10 is a side view of the rear suspension, rear compressed side view of rear suspension with rear shock compressed, front shock extended. FIG. 11 is a side view of the rear suspension, front compressed side view of rear suspension with front shock compressed, rear shock extended. FIG. 12 is a side view of the rear suspension, fully compressed side view of rear suspension with both front and rear shocks compressed.

### B. Chassis.

The chassis structure 10 is unique and consists of side 11 and center plates 12 connected by several perpendicular cross tubes 15 and shafts 17. The function of the chassis structure 10 is to provide for mounting the tracked rear suspension 40, driveline 20, and brake system 30 to the motorcycle chassis and also provides suspension compliance. The front most pivot point 16 connects to the existing motorcycle swing arm pivot through a compliant link 14 that replaces the motorcycle rear shock absorber.

The chassis structure 10 method of construction is unique and consists of side 11 and center plates 12 connected by several perpendicular cross tubes 15 and shafts 17. This 2D approach allows for simple construction using standard machine tools and eliminates all welding which provides for a lighter, more rigid, higher strength, modular, and tighter tolerance system compared to other designs. All cross tubes 15 and shafts 17 are mounted to the side plates 11 with large cross section fasteners that provide high strength in both bending and shear.

The chassis structure 10 provides for mounting the tracked rear suspension 40, driveline 20, and brake system 30 to the motorcycle chassis and also provides suspension compliance. The front most pivot 16 point connects to the existing motorcycle swing arm pivot. The load from the suspension is directed along the side plates 11 and through the cross tubes 15 to the center chassis structure 10 and a compliant link 14 that replaces the motorcycle rear shock absorber. This allows the entire chassis structure 10 to rotate a small amount about the swing arm pivot axis from suspension loads.

The side plates 11 also provide rider protection from snow and the rotating components such as chains 25, 26, sprockets 27, 28, 29, and track 49. An additional cover, or fender 13, preferably made from plastic, can be used on the top side of the chassis structure 10 to provide additional rider protection.

Alternatively, the chassis structure side plates 11 and fender 13 could be replaced with longer variations to accommodate longer travel suspensions versions of the kit.

### C. Driveline.

The driveline 20 consists of a jackshaft assembly 22 and driveshaft assembly 23. Eccentric bearing carriers 24, sprockets 27, 28, 29 & chains 25, 26 located inside the outer side plates 11 of the chassis 10 to simplify the structure.

A first chain 25 from the motorcycle output shaft is connected to the jackshaft assembly 22 and a second chain 26 is connected from the jackshaft assembly 22 to the driveshaft assembly 23 which drives the rubber track 49. Chain tension adjustment is accomplished by unique eccentric bearing carriers 24.

The driveline 20 consists of a jackshaft assembly 22 and driveshaft assembly 23 and is efficiently integrated into the side 11 and center plates 12 of the chassis structure 10. A first chain 25 from the motorcycle output shaft is connected to the jackshaft assembly 22 and a second chain 26 is connected from the jackshaft assembly 22 to the driveshaft assembly 23 which drives the rubber track 49.

All driveline 20 components are located inside the outer side plates 11 to simplify the chassis structure 10 and also provide rider protection without the need for having additional covers.

Gear ratio changes can be made by changing the sprocket sizes through removal of the jackshaft assembly 22. This change can be done without disassembling any of the chassis structure 10.

Chain tension adjustment is accomplished by unique eccentric bearing carriers 24. Both the driveshaft assembly 23 and jackshaft assembly 22 bearings are mounted in eccentric bearing carriers 24 which mount to the offset driveline side plate 21. By rotating eccentrics, the bearing moves relative to the side plate and the shaft center distance can be adjusted up to ¾ of an inch. The rotation of the eccentric is not infinite and is limited to the number of holes in the eccentric flange. This design is limited to 15 degree increments. A beauty ring both covers the eccentric and retains the bearing.

Alternatively, gear ratio changes will be necessary to accommodate different power to weight ratios of current and past motorcycle models available on the market today. Large gear ratio changes will require changes to primary drive chain 25 and secondary chain 26 lengths.

### D. Brakes.

The brake system structure 30 consists of a brake disc 32 and custom brake caliper 31. The brake disk 32 mounts to the jackshaft assembly 22 and the custom brake caliper 31 mounts to the offset driveline side plate 21 of the chassis 10. The brake caliper 31 is a floating type caliper. The braking system 30 is designed to integrate with the existing motorcycle braking system via a brake line connected to the custom brake caliper 31 brake line connection fitting 33 to the existing motorcycle rear braking system.

The brake disc 32 is mounted on the jackshaft assembly 22 and is located inside the outer side plates 11 to provide for rider protection. The custom brake caliper 31 is floating and mounting is integrated into the outer offset driveline side plate 21. The brake system 30 allows the rider to better control deceleration of the snow bike.

### E. Rear Suspension.

The suspension 40 architecture is similar to late model snowmobile architectures but differs in many ways. Both use rail assemblies 41 to support and guide the rubber track 49, front arm assembly 44, rear arm assembly 46, front shock absorber 43 and rear shock absorber 43. However, this architecture is optimized for use on a motorcycle. The suspension 40 is considered uncoupled. The suspension 40 has a linkage driven rear track shock absorber 45 to yield a linear motion ratio.

The rear suspension 40 construction method is similar to the chassis structure 10 which uses parallel plates, or arms, and cross shafts. This method is efficient for production on modern machine tools and again eliminates welding, reduces weight, increases strength, and improves rigidity.

Suspension 40 architecture is optimized for use on a motorcycle which has very different power and weight characteristics. Suspension 40 parameters such as front arm assembly 44 placement, idler wheel size and placement has been designed to provide for improved weight transfer and traction performance specifically for a motorcycle. The uncoupled short track design also improves the ride and weight transfer for this type of vehicle. Ride quality is improved by using a linkage driven rear shock absorber to yield a linear motion ratio. Compliance in the connection between the chassis structure 10 and motorcycle chassis by use of the compliant link provides for a series suspension system which also improves ride quality and bottom out resistance.

Alternatively, rear suspension 40 lengths will be offered to accommodate snow depths and riding styles. Longer track lengths require changes to rail assembly 41 length, rear shock absorber 45, front arm assembly 44, rear arm assembly 46, and rubber track 49. Alternative rubber track styles will be offered in addition to length variations. Rubber tracks 49 with a radius outside profile will be offered for hard pack and groomed trail type conditions.

### F. Component Connections.

The chassis 10 is the main structure of the entire system. The chassis 10 consists of side 11 and center plates 12 connected by several perpendicular cross tubes 15 and shafts 17. The fender 13 is mounted on the top section of the chassis 10 assembly as shown in FIG. 1. The chassis 10 mounts to the motorcycle via the lower main pivot mounts 16 and the compliant link 14 shown in FIG. 3 and the compliant mount 14 shown in FIG. 7.

The driveline 20 component structure is integrated into the chassis 10 components via the offset driveline side plate 21, shown in FIG. 3. The driveline system 20 is driven by the motorcycle output shaft drive sprocket 27 shown in FIG. 4. The jackshaft assembly 22 transfers motion to the driveshaft assembly 23 via the secondary drive chain 26.

Brake caliper 31 mounts to the offset driveline side plate 21 as shown in FIG. 5. FIG. 6 shows the location of the disc brake 32 mounted to the jackshaft assembly 22. The suspension 40 mounts into the chassis 10 via the mounting locations in the front arm assembly 44 and the rear arm assembly 46. The suspension 40 consists of the rail assemblies 41 which are connected by perpendicular cross shafts. The front shock absorber 43 connects the front arm assembly 44 and the rail assemblies 41 via cross shafts. The rear shock absorber 45 connects the rear arm assembly 46 to the rail assemblies 41 via cross shafts shown in FIG. 7 and FIG. 8.

### A. Operation of Preferred Embodiment

There are several similar conversion kits available in the aftermarket but all have several short comings. A discussion of the improvements this invention has over these current designs follows.

The chassis structure method of construction is unique and consists of side and center plates connected by several perpendicular cross tubes and shafts. This 2D approach allows for simple construction using standard machine tools and eliminates all welding which provides for a lighter, more rigid, higher strength, modular, and tighter tolerance system compared to other designs. All cross tubes and shafts are mounted to the side plates with large cross section fasteners that provide high strength in both bending and shear.

The chassis structure provides for mounting the tracked rear suspension, driveline, and brake system to the motorcycle chassis and also provides suspension compliance. The front most pivot point connects to the existing motorcycle swing arm pivot. Load from the suspension is directed along the side plates and through the cross tubes to the center chassis structure and a compliant link that replaces the motorcycle rear shock absorber. This allows the entire chassis structure to rotate a small amount about the swing arm pivot axis from suspension loads.

The side plates also provide rider protection from snow and the rotating components such as chains, sprockets, and track. An additional cover, or fender, preferably made from plastic, can be used on the top side of the chassis structure to provide additional rider protection.

The driveline consists of a jackshaft and driveshaft and is efficiently integrated into the side and center plates of the chassis structure. A first chain from the motorcycle output shaft is connected to the jackshaft and a second chain is connected from the jackshaft to the driveshaft which drives the rubber track. All driveline components are located inside the outer side plates to simplify the chassis structure and also provide rider protection without the need for having additional covers. Gear ratio changes can be made by changing the sprocket sizes through removal of the jackshaft. This change can be done without disassembling any of the chassis structure.

Chain tension adjustment is accomplished by unique eccentric adjusters. Both the driveshaft and jackshaft bearings are mounted in eccentric carriers which mount to the chassis plates. By rotating eccentrics, the bearing moves relative to the side plate and the shaft center distance can be adjusted up to ¾ of an inch. The rotation of the eccentric is not infinite and is limited to the number of holes in the eccentric flange. This design is limited to 15 degree increments. A beauty ring both covers the eccentric and retains the bearing.

The brake disc is mounted on the jackshaft and is located inside the outer side plates to provide for rider protection. The custom caliper is floating and mounting is integrated into the outer side plate.

The rear suspension construction method is similar to the chassis structure which uses parallel plates, or arms, and cross shafts. This method is efficient for production on modern machine tools and again eliminates welding, reduces weight, increases strength, and improves rigidity.

Suspension architecture is similar to late model snowmobile architectures but differs in many ways. Both use a rail beams to support and guide the track, front arm, rear arm, and front and rear shocks. However, this architecture is optimized for use on a motorcycle which has very different power and weight characteristics.

Suspension parameters such as front arm placement and wheel size and placement has been designed to provide for improved weight transfer and traction. The uncoupled short track design also improves the ride and weight transfer for this type of vehicle.

Ride quality is improved by using a linkage driven rear track shock to yield a linear motion ratio. Compliance in the connection between the chassis structure and motorcycle chassis by use of the compliant link provides for a “series” suspension system which also improves ride quality and bottom out resistance.

The vehicle frame (e.g. conventional motorcycle frame, OEM frame; custom fabricated frame, etc.) supports a motor similar to how a motorcycle frame supports a motor. The motor is used to provide power to the endless track thereby rotating the endless track. A series rear suspension is movably (e.g. pivotally) connected to the vehicle frame wherein the series rear suspension is comprised of two or more suspensions that are connected together in series. The series rear suspension comprises a chassis structure comprising a first side, a second side, and a cross member extending between the first and the second side. A main pivot mount is connected to a front portion of the chassis structure. The main pivot mount is adapted to pivotally mount to the vehicle frame. The main pivot mount is adapted to pivotally mount to a swing arm pivot of the vehicle frame.

A first suspension is movably attached between the vehicle frame and the chassis structure. The first suspension preferably provides a linear force to separate the chassis structure and the vehicle frame. A second suspension is movably connected to the chassis structure. The second rear suspension comprises a plurality of upper rollers, a rail assembly and an endless track similar to a conventional snowmobile rear suspension. The endless track moves along a path around the plurality of upper rollers and the rail assembly similar to a conventional snowmobile rear suspension.

The first suspension is comprised of a compliant link that is movable along a linear axis. The first suspension may be comprised of any device that any device that elastically resists a change in linear deformation and/or linear velocity. The first suspension is preferably comprised of a linear force element but may be comprised of any number of components connected together to provide a movable support connection between the vehicle frame and the chassis structure. The linear force element may be comprised of a device that resists linear compression such as, but not limited to, a spring, a shock absorber, an air shock, a hydraulic shock, a damper, a combination damper and coil spring, a linear movable strut or any combination thereof. The first suspension preferably acts in a linear fashion. The linear force may dependent on both position (elastic deformation) and velocity. The elastic material could be rubber, polymer, or any type of metal. The damping material could be a result of friction, either internal to a material, hydraulic, or mechanical. For example, the simplest device usable as a first suspension could be a puck of rubber sandwiched between two cones to provide both a linear resistance force and damping. U.S. Pat. No. 7,891,454 is incorporated by reference herein for the purpose of disclosing examples of suitable linear force elements.

The first suspension may be connected to the chassis structure and the vehicle frame via compliant bushings (e.g. rubber bushing) rather than solid pivot connections to provide a third suspension in series with the first suspension and the second suspension. The third suspension is connected either between the chassis structure and the first suspension or between the chassis structure and the second suspension.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A rear suspension for a snow bike, comprising:
a chassis structure comprising a first side and a second side;
a main pivot mount connected to a front portion of the chassis structure, wherein the main pivot mount is adapted to pivotally mount to a vehicle frame;
a first suspension connected to the chassis structure, wherein the first suspension is adapted to be connected to the vehicle frame; and
a second suspension connected to the chassis structure, wherein the second rear suspension comprises a plurality of upper rollers, a rail assembly and an endless track, wherein the endless track moves along a path around the plurality of upper rollers and the rail assembly.

2. The rear suspension for a snow bike of claim 1, wherein the main pivot mount is adapted to pivotally mount to a swing arm pivot of the vehicle frame.

3. The rear suspension for a snow bike of claim 1, wherein the first suspension is comprised of a compliant link.

4. The rear suspension for a snow bike of claim 3, wherein the compliant link is comprised of a linear force element.

5. The rear suspension for a snow bike of claim 4, wherein the linear force element is comprised of a device that resists linear compression.

6. The rear suspension for a snow bike of claim 4, wherein the linear force element is comprised of a shock absorber.

7. The rear suspension for a snow bike of claim 4, wherein the linear force element is comprised of a spring.

8. The rear suspension for a snow bike of claim 4, wherein the linear force element is comprised of a shock absorber and a spring.

9. The rear suspension for a snow bike of claim 4, wherein the linear force element is comprised of an air shock.

10. The rear suspension for a snow bike of claim 1, wherein the first suspension provides a linear force.

11. A snow bike, comprising:
a vehicle frame supporting a motor; and
a series rear suspension connected to the vehicle frame, wherein the series rear suspension comprises:
a chassis structure comprising a first side and a second side;
a main pivot mount connected to a front portion of the chassis structure, wherein the main pivot mount is adapted to pivotally mount to the vehicle frame;
a first suspension connected between the vehicle frame and the chassis structure; and
a second suspension movably connected to the chassis structure, wherein the second rear suspension comprises a plurality of upper rollers, a rail assembly and an endless track, wherein the endless track moves along a path around the plurality of upper rollers and the rail assembly.

12. The snow bike of claim 11, wherein the main pivot mount is adapted to pivotally mount to a swing arm pivot of the vehicle frame.

13. The snow bike of claim 11, wherein the first suspension is comprised of a compliant link.

14. The snow bike of claim 13, wherein the compliant link is comprised of a linear force element.

15. The snow bike of claim 14, wherein the linear force element is comprised of a device that resists linear compression.

16. The snow bike of claim 14, wherein the linear force element is comprised of a shock absorber.

17. The snow bike of claim 14, wherein the linear force element is comprised of a spring.

18. The snow bike of claim 14, wherein the linear force element is comprised of a shock absorber and a spring.

19. The snow bike of claim 14, wherein the linear force element is comprised of an air shock.

20. The snow bike of claim 11, wherein the first suspension provides a linear force.
